(19) United States
(12) Patent Application Publication
(10) Pub. No.: US 2008/0155605 A1
(43) Pub. Date: Jun. 26, 2008

(54) METHOD AND APPARATUS FOR SELECTING DIGITAL BROADCAST CHANNEL

(75) Inventor: Sung-min Jeon, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/744,276

(22) Filed: May 4, 2007

(30) Foreign Application Priority Data
Dec. 20, 2006 (KR) 10-2006-0130836

(51) Int. Cl. G06F 3/00

(52) U.S. Cl. 725/47

(57) ABSTRACT

An apparatus and method for selecting a broadcast channel are provided. The apparatus includes a controller which constructs a broadcast information providing screen image such that broadcast information of each of a plurality of channels is arranged at a location corresponding to a location of each of a plurality of user input keys, based on arrangement information of at least one piece of the user input keys; a display processor which controls outputting of the broadcast information providing screen image; and a user input signal receiving unit which receives an input signal from one of the user input keys, wherein the controller selects a broadcast channel corresponding to broadcast information at a location corresponding to a location of the user input key through which the input signal is received.

### CROSS-REFERENCE TO RELATED PATENT APPLICATIONS

This application claims priority from Korean Patent Application No. 10-2006-0130836, filed on Dec. 20, 2006, in the Korean Intellectual Property Office, the disclosure of which is incorporated herein in its entirety by reference.

### BACKGROUND OF THE INVENTION

1. Field of the Invention

The present invention relates to a method and apparatus for selecting a broadcast channel, and more particularly, to a broadcast channel selecting method and apparatus for providing a screen image that matches the layout of a user input device through which a broadcast channel can be selected, thereby enabling a user to instinctively and effectively select a broadcast channel.

2. Description of the Related Art

As the types of digital broadcasting transmission media become more diversified, including terrestrial wave, satellite, and cable, the total number of digital broadcast channels is increased. Also, existing terrestrial digital broadcasting provides one high definition (HD) channel in a predetermined frequency band of 6 MHz. However, in addition to an HD rate video channel, a multi-mode service (MMS) that transmits a standard definition (SD) rate video channel/audio channel/data channel are provided in a conventional frequency band. In the case of the MMS, a channel number includes a major channel number and sub channel numbers.

In order to input the number of a broadcast channel and select a broadcast program under such an environment, a user must press number keys for selecting the broadcast channel on a user input device several times. Also, when selecting a broadcast channel in an on-screen electronic program guide (EPG), the user must press arrow keys on a user input device several times, and further press a button for selecting the broadcast channel.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method and apparatus for selecting a broadcast channel by providing a screen image that corresponds to an input key layout of a user input device through which a desired broadcast channel is selected, thereby allowing a user's instinctive selection of a broadcast channel.

According to an aspect of the present invention, there is provided a method of selecting a broadcast channel, the method including constructing a broadcast information providing screen image so that broadcast information of each of a plurality of channels is displayed at a location corresponding to a location of each of a plurality of user input keys, based on arrangement information of at least one piece of the user input keys; outputting the broadcast information providing screen image; and if an input signal is received from one of the user input keys, selecting a broadcast channel corresponding to broadcast information at a location corresponding to a location of the user input key through which the input signal is received.

The constructing of the broadcast information providing screen image may include mapping an identification value which identifies an input signal received through each of the user input keys to broadcast information at a location corresponding to the location of each of the user input keys.

If an input signal requesting a broadcast information providing screen image that contains broadcast information of another channel is received, the method may further include updating the mapping so that the identification value of the input signal received through each of the user input keys indicates broadcast information at the location corresponding to the location of each of the user input keys in the broadcast information providing screen image.

If the user input keys are arranged in a matrix format having a size, the broadcast information providing screen image may be constructed so that cells containing broadcast information are arranged in a matrix format having a size equal to the size of the matrix of the user input keys.

If the cells are arranged in a matrix format, one axis of the matrix of cells may denote channels of each broadcaster, and the other axis of the matrix of cells may denote sub channels of the channels of each broadcaster.

At least one piece of the broadcast information may comprise at least one of a title and a broadcast channel of a broadcast program that is currently being broadcast.

The at least one piece of the broadcast information may comprise an image representing the broadcast program.

The user input keys may be constructed with numbered buttons.

According to another aspect of the present invention, there is provided an apparatus for selecting a broadcast channel, the apparatus including a controller which constructs a broadcast information providing screen image such that broadcast information of each of a plurality of channels is arranged at a location corresponding to a location of each of a plurality of user input keys, based on arrangement information of at least one piece of the user input keys; a display processor which controls outputting of the broadcast information providing screen image; and a user input signal receiving unit which receives an input signal from one of the user input keys, wherein the controller selects a broadcast channel corresponding to broadcast information at a location corresponding to a location of the user input key through which the input signal is received.

According to another aspect of the present invention, there is provided a computer readable medium having recorded thereon a method of selecting a broadcast channel, the method including constructing a broadcast information providing screen image so that broadcast information of each of a plurality of channels is displayed at a location corresponding to a location of each of a plurality of user input keys, based on arrangement information of at least one piece of the user input keys; outputting the broadcast information providing screen image; and if an input signal is received from one of the user input keys, selecting a broadcast channel corresponding to broadcast information at a location corresponding to a location of the user input key through which the input signal is received.

### BRIEF DESCRIPTION OF THE DRAWINGS

The above and other aspects of the present invention will become more apparent by describing in detail exemplary embodiments thereof with reference to the attached drawings in which:

FIG. 1 illustrates a broadcast channel selecting apparatus and a user input device according to an exemplary embodiment of the present invention;

FIG. 2 illustrates a broadcast information providing screen image that is constructed according to the arrangement of user input keys of a user input device, according to another exemplary embodiment of the present invention;

FIG. 3 is a block diagram of a broadcast channel selecting apparatus according to an exemplary embodiment of the present invention;

FIG. 4 illustrates mapping of an identification value of an input signal received through each user input key so as to broadcast information contained in a broadcast information providing screen image, according to an exemplary embodiment of the present invention;

FIG. 5 is a flowchart of a method of selecting a broadcast channel according to an exemplary embodiment of the present invention; and

FIG. 6 is a flowchart of a method of selecting a broadcast channel according to another exemplary embodiment of the present invention.

### DETAILED DESCRIPTION OF EXEMPLARY EMBODIMENTS OF THE INVENTION

Hereinafter, exemplary embodiments of the present invention will be described in detail with reference to the accompanying drawings.

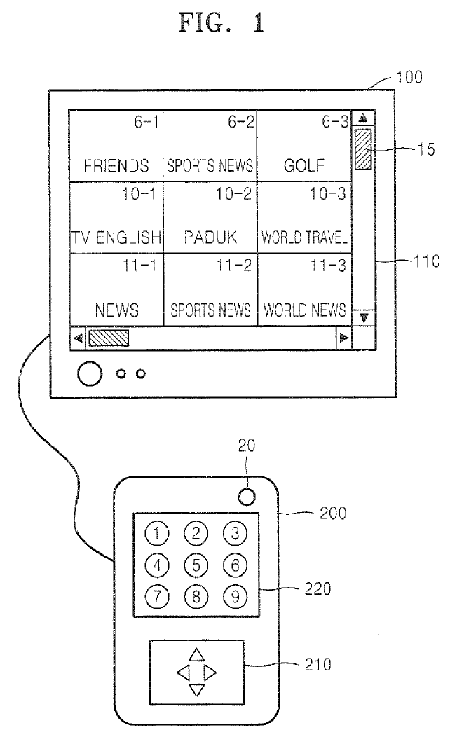

FIG. 1 illustrates a broadcast channel selecting apparatus 100 and a user input device 200 according to an exemplary embodiment of the present invention.

According to the present embodiment, when a user presses a broadcast channel selection mode key 20 for selecting a broadcast channel, the broadcast channel selecting apparatus 100 outputs a broadcast information providing screen image, such as a screen image 110, to a display unit.

In the broadcast channel selecting apparatus 100, arrangement information of user input keys 220 of the user input device 200, which are used to select a broadcast channel, is set. The broadcast information providing screen image 110 is constructed so that each piece of broadcast information is displayed at a location corresponding to the location of each of the user input keys 220, based on at least one piece of the arrangement information of the user input keys 220.

The arrangement information of the user input keys 220 is information regarding the layout of the user input keys 220 for selecting a broadcast channel. Also, the arrangement information of the user input keys 220 is information for constructing a screen image that provides at least one piece of broadcast information. The type of arrangement information is not limited. For example, if the user input keys 220 are arranged in a matrix format having a predetermined size, the arrangement information of the user input keys 220 may specify the total numbers of rows and columns of the matrix.

Referring to FIG. 1, the user input keys 220 of the user input device 200, which are used to select a broadcast channel, are arranged in 3 rows and 3 columns, and the broadcast channel selecting apparatus 100 provides the broadcast information providing screen image 110, in which broadcast information is displayed in 3 rows and 3 columns in order to correspond to the arrangement of the user input keys 220. The shape of the broadcast information providing screen image 110 may be variously constructed according to the arrangement of the user input keys 220 for selecting a broadcast channel.

When a key ‘1’ is pressed from among the user input keys 220 of the user input device 200, which are used to select a broadcast channel, a broadcast channel corresponding to broadcast information that is provided at a location corresponding to the key ‘1’ is selected. For example, if a channel 6-1 is selected and tuned in the broadcast channel selecting apparatus 100, a broadcast program entitled “Friends” may be output. In a related art apparatus, keys ‘6’, ‘-’, and ‘1’ must be pressed to select the channel 6-1. In contrast, according to an exemplary embodiment of the present invention, a user can select a desired broadcast channel by instinctively pressing one of the user input keys 220 only once, which corresponds to a location where broadcast information is provided, on the user input device 200.

When all pieces of broadcast information are not displayed in a screen image, i.e., when broadcast information of only a certain number of channels can be displayed, it is possible to construct a broadcast information providing screen image 110 so that broadcast information of the other channels can be displayed by moving a scroll bar 15. Otherwise, a user may request a broadcast information providing screen image 110 that provides the broadcast information of another channel by using one of the arrow keys 210, and the broadcast channel selecting apparatus 100 may output the requested broadcast information providing screen image 110.

The broadcast channel selecting apparatus 100 may be a digital broadcast receiver. FIG. 1 illustrates that the broadcast channel selecting apparatus 100 and the user input device 200 are connected through a wire. However, the broadcast channel selecting apparatus 100 and the user input device 200 may be constructed to establish wireless communication, or may be unified as one device.

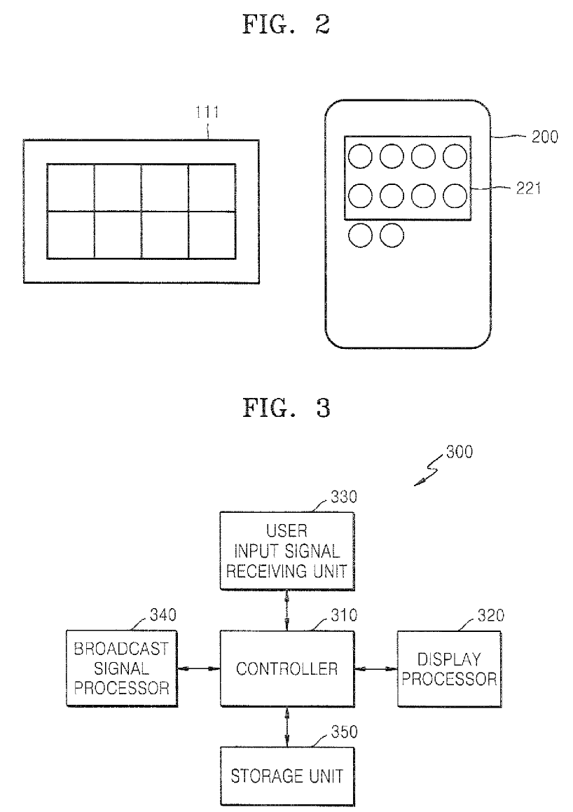

FIG. 2 illustrates a broadcast information providing screen image 111 according to the arrangement of user input keys 221 on a user input device 200, according to another exemplary embodiment of the present invention. If the user input keys 221 allocated to the user input device 200 in order to select a desired broadcast channel are arranged in two rows and four columns, the broadcast channel selecting apparatus 100 is capable of providing the broadcast information providing screen image 111 in two rows and four columns, which corresponds to the arrangement of the user input keys 221, based on the arrangement information of the user input keys 221.

To this end, when the broadcast channel selecting apparatus 100 is initially used, the arrangement information of the user input keys 221 may be set in the broadcast channel selecting apparatus 100. As illustrated in FIG. 2, if the broadcast channel apparatus 100 is constructed separately from the user input device 200, even if the user input device 200, such as a remote controller, is changed so that the arrangement of the user input keys 221 is changed, the broadcast information providing screen image 111 may be constructed to visually correspond to the key arrangement of the user input device 200 by setting the arrangement information of the user input keys 221 in the broadcast channel selecting apparatus 100.

FIG. 3 is a block diagram of a broadcast channel selecting apparatus 300 according to an exemplary embodiment of the present invention. The broadcast channel selecting apparatus 300 includes a controller 310, a display processor 320, a user input signal receiving unit 330, a broadcast signal processor 340, and a storage unit 350.

The user input signal receiving unit 330 receives an input signal from a user input key of the user input device 200 and transmits it to the controller 310.

The controller 310 constructs a broadcast information providing screen image so that broadcast information of each channel is displayed at a location corresponding to the location of each user input key, based on the arrangement of at least one piece of information of user input keys. In this case, the broadcast information provided in the broadcast information providing screen image may be broadcast information corresponding to a current time period. The arrangement information of the user input keys may be stored in a predetermined storage space of the controller 310. Otherwise, the arrangement information of the user input keys may be stored in the storage unit 350, and the controller 310 may refer to the arrangement information when constructing the broadcast information providing screen image.

For example, when the user input keys are arranged in a matrix format having a predetermined size, the controller 310 constructs a screen image such that cells containing broadcast information are arranged in a matrix format having a size equal to the predetermined size. As illustrated in FIG. 1, the screen image may be constructed in 3 rows and 3 columns. When the cells are arranged in a matrix format, the controller 310 may construct a screen image in which one axis of the matrix denotes a channel of each broadcaster and the other axis denotes sub channels of the channel of each broadcaster.

Also, the at least one piece of the broadcast information may contain one of the title and the broadcast channel of a broadcast program that is currently being broadcast. Also, an image representing a broadcast program in the form of thumbnail may be contained in a cell providing the broadcast information.

The display processor 320 controls the screen image that is provided from the controller 310 and through which broadcast information is provided, to be output to and displayed in a display device (not shown).

The controller 310 selects a broadcast channel corresponding to broadcast information that is provided at a location corresponding to one of the user input keys through which the input signal is received. To this end, according to an exemplary embodiment of the present invention, the controller 310 maps an identification value of an input signal received through each of the user input keys to broadcast information that is provided at a location corresponding to the location of each user input key. Thus, when an input signal is received through one user input key, a broadcast channel corresponding to broadcast information mapped to an identification value of the received input signal may be selected.

Broadcast information mapped to and indicated by an identification value of the input signal received through each of the user input keys is updated according to a broadcast information providing screen image. Accordingly, a change in broadcast information results in a change in each broadcast information mapped to each identification value.

Accordingly, when a user input signal requesting a broadcast information providing screen image that contains broadcast information of another channel is received through the user input unit 330, the controller 310 updates the mapping so that an identification value of an input signal received through each user input key indicates broadcast information provided at a location corresponding to the location of each user input key.

The broadcast signal processor 340 is an indispensable element when the broadcast channel selecting apparatus 300 is constructed as a digital broadcast receiver. When the broadcast signal processor 340 transmits broadcast data transmitted through a digital broadcast signal and broadcast information, such as an electronic program guide (EPG), to the controller 310, the controller 310 may store the received broadcast data and the broadcast information to the storage unit 350, or decode them and output the broadcast data and the broadcast information to the display processor 320. The broadcast signal processor 340 may be constructed to process a broadcast signal according to a transport standard based on the path, such as satellite, terrestrial wave, or cable, through which a digital broadcast signal is transmitted. If the controller 310 selects a broadcast channel based on the user input signal, the controller 310 may control the broadcast signal processor 340 to tune the selected broadcast channel.

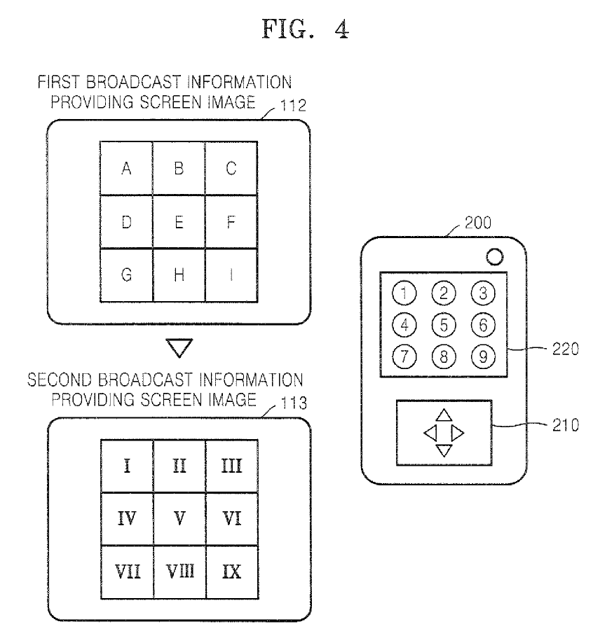

FIG. 4 illustrates mapping of an identification value of an input signal received through each user input key to broadcast information contained in a broadcast information providing screen image, according to an exemplary embodiment of the present invention. ‘A’ through ‘I’ indicated in the cells of a first broadcast information providing screen image 112, and ‘I’ through ‘IX’ indicated in the cells of a second broadcast information providing screen image 113, schematically represent a plurality of pieces of broadcast information of channels which are provided in the cells.

It is assumed that when a user requests a broadcast information providing screen image, the first broadcast information providing screen image 112 is displayed on the broadcast channel selecting apparatus 100. If user input keys are constructed with numbered buttons 200, an identification value identifying an input signal received through a user input key 1 is mapped to the broadcast information A, and an identification value identifying an input signal received through a user input key 2 is mapped to the broadcast information B. The other identification values which identify input signals received through the other user input keys are respectively mapped to broadcast information corresponding to the locations of the other user input keys in the first broadcast information providing screen image 112.

When a part of the broadcast information is provided and a user requests broadcast information of another channel, the controller 310 updates the mapping of identification values of input signals received through the respective user input keys to broadcast information contained in a broadcast information providing screen image that is to be provided based on the request. If the broadcast channel selecting apparatus 100 provides the second broadcast information providing screen image 113 based on a request of the user, an identification value identifying an input signal received through the user input key 1 is updated to be mapped to the broadcast information I, and an identification value identifying an input signal received through the user input key 2 is updated to be mapped to the broadcast information 11. The identification values identifying input signals received through the other user input keys are also updated to be respectively mapped to a plurality of pieces of broadcast information corresponding to the locations of the other user input keys in the second broadcast information providing screen image 113. Thus, if the second broadcast information providing screen image 113 is provided, when the user selects the user input key 1, a broadcast channel corresponding to the broadcast information I in the second broadcast information providing screen image 113 may be selected and tuned in.

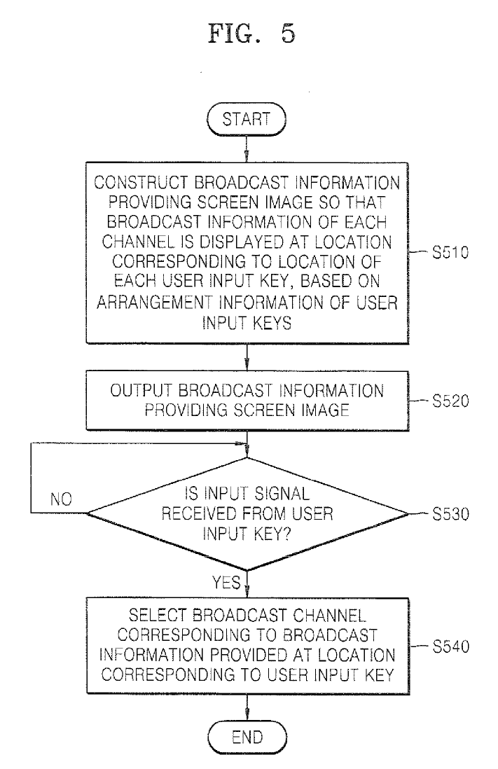

FIG. 5 is a flowchart of a method of selecting a broadcast channel according to an exemplary embodiment of the present invention. In operation S510, the controller 310 constructs a broadcast information providing screen image so that broadcast information of each channel is displayed at a location corresponding to the location of each user input key, based on the arrangement information of at least one piece of the user input keys.

In operation S520, a broadcast information providing screen image constructed by the controller 310 is outputted and displayed under the control of the display processor 320.

If an input signal is received from the user input signal receiving unit 330 through one of user input keys in operation S530, the controller 310 selects a broadcast channel corresponding to broadcast information provided at a location corresponding to the location of the user input key in operation S540.

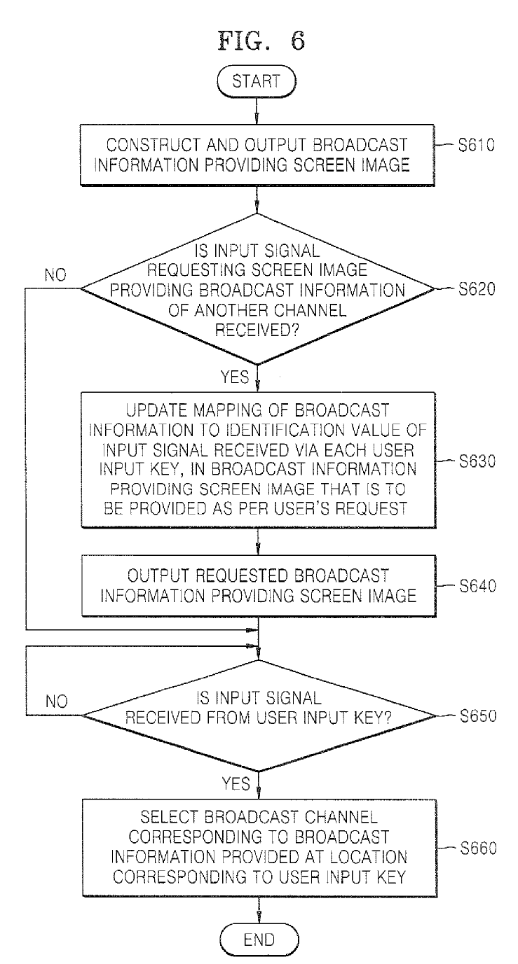

FIG. 6 is a flowchart of a method of selecting a broadcast channel according to another exemplary embodiment of the present invention. In operation S610, the controller 310 constructs a broadcast information providing screen image so that broadcast information of each channel is displayed at a location corresponding to the location of each user input key, based on the arrangement information of at least one piece of the user input keys, and outputs the broadcast information providing screen image, under the control of the display processor 320.

If a user input signal requesting broadcast information of another channel is received through the user input signal receiving unit 330 in operation S620, the controller 310 updates the mapping of broadcast information to an identification value of an input signal received through each user input key in a broadcast information providing screen image that is to be provided based on a request of a user, and constructs the broadcast information providing screen image in operation S630.

In operation S640, a screen image providing the requested broadcast information is outputted under the control of the display processor 320.

If an input signal is received through the user input signal receiving unit 330 from one of the user input keys in operation S650, the controller 310 selects a broadcast channel corresponding to broadcast information indicated by an identification value of the received input signal, that is, the broadcast information provided at a location corresponding to the user input key, in operation S660.

The present invention can be embodied as computer readable code in a computer readable medium. Here, the computer readable medium may be any recording apparatus capable of storing data that is read by a computer system, such as a read-only memory (ROM), a random access memory (RAM), a compact disc (CD)-ROM, a magnetic tape, a floppy disk, and an optical data storage device. The computer readable medium can be distributed among computer systems that are interconnected through a network, and exemplary embodiments of the present invention may be stored and implemented as computer readable code in the distributed system.

As described above, according to exemplary embodiments of the present invention, a broadcast information providing screen image is constructed based on the arrangement information of user input keys of a user input device, thereby allowing a user's instinctive selection of a broadcast channel. Since the user can select a broadcast channel and watch a broadcast program transmitted through the selected broadcast channel by pressing a user input key only once, it is possible to minimize the number of times that a user must press a key to select the broadcast channel, thereby increasing the user's convenience.

While this invention has been particularly shown and described with reference to exemplary embodiments thereof, it will be understood by those skilled in the art that various changes in form and details may be made therein without departing from the spirit and scope of the invention as defined by the appended claims and their legal equivalents.

What is claimed is:

1. A method of selecting a broadcast channel, comprising:
constructing a broadcast information providing screen image so that broadcast information of a plurality of channels are displayed at locations corresponding to locations of a plurality of user input keys, based on arrangement information of at least one piece of the plurality of user input keys;
outputting the broadcast information providing screen image; and
if an input signal is received from one of the plurality of user input keys, selecting one of the plurality of channels corresponding to one of the broadcast information at a location corresponding to the one of the plurality of user input keys.

2. The method of claim 1, wherein the constructing of the broadcast information providing screen image comprises mapping an identification value which identifies an input signal received through one of the plurality of user input keys, to one of the broadcast information at a location corresponding to a location of one of the plurality of user input keys.

3. The method of claim 2, further comprising, if an input signal requesting another broadcast information providing screen image that contains broadcast information of another channel is received, updating the mapping so that another identification value of another input signal received through another of the plurality of user input keys indicates another broadcast information at a location corresponding to a location of another of the plurality of user input keys, in the other broadcast information providing screen image.

4. The method of claim 1, wherein the plurality of user input keys are arranged in a first matrix having a first size, and the broadcast information providing screen image is constructed so that cells containing the broadcast information are arranged in a second matrix having a second size equal to the first size.

5. The method of claim 4, wherein one axis of the second matrix denotes channels of broadcasters, and another axis of the second matrix denotes sub channels of the channels of broadcasters.

6. The method of claim 1, wherein one of the broadcast information comprises at least one of a title and a broadcast channel of a broadcast program that is currently being broadcast.

7. The method of claim 6, wherein the one of the broadcast information comprises an image representing the broadcast program.

8. The method of claim 1, wherein the plurality of user input keys comprise numbered buttons.

9. An apparatus for selecting a broadcast channel, comprising:
a controller which constructs a broadcast information providing screen image such that broadcast information of a plurality of channels are arranged at locations corresponding to locations of a plurality of user input keys, based on arrangement information of at least one piece of the plurality of user input keys;
a display processor which controls outputting of the broadcast information providing screen image; and
a user input signal receiving unit which receives an input signal from one of the plurality of user input keys,
wherein the controller selects a broadcast channel corresponding to one of the broadcast information at a location corresponding to a location of the one of the plurality of user input keys through which the input signal is received.

10. The apparatus of claim 9, wherein the controller maps, in a mapping, an identification value which identifies the input signal received through the one of the plurality of user input keys, to the one of the broadcast information at the location corresponding to the location of the one of the plurality of user input keys.

11. The apparatus of claim 9, wherein, if another input signal requesting a broadcast information providing screen image that contains broadcast information of another channel is received through the user input signal receiving unit, the controller updates the mapping so that an identification value which identifies the another input signal received through another of the plurality of user input keys indicates the broadcast information of another channel at a location corresponding to a location of another of the plurality of user input keys in the broadcast information providing screen image.

12. The apparatus of claim 9, wherein the plurality of user input keys are arranged in a first matrix having a first size, and the controller constructs the broadcast information providing screen image so that cells containing the broadcast information are arranged in a second matrix having a second size equal to the first size.

13. The apparatus of claim 9, wherein the one of broadcast information comprises at least one of a title and a broadcast channel of a broadcast program that is currently being broadcast.

14. The apparatus of claim 13, wherein the one of the broadcast information comprises an image representing a broadcast program.

15. The apparatus of claim 12, wherein the controller constructs the broadcast information providing screen image so that one axis of the second matrix denotes channels of broadcasters, and another axis of the second matrix denotes sub channels of the channels of broadcasters.

16. The apparatus of claim 9, wherein the plurality of user input keys comprise numbered buttons.

17. A computer readable medium having recorded thereon a computer program for executing a method of selecting a broadcast channel, the method comprising:
constructing a broadcast information providing screen image so that broadcast information of a plurality of channels are displayed at locations corresponding to locations of a plurality of user input keys, based on arrangement information of at least one piece of the plurality of user input keys;
outputting the broadcast information providing screen image; and
if an input signal is received from one of the plurality of user input keys, selecting one of the plurality of channels corresponding to broadcast information at a location corresponding to the one of the plurality of user input keys.
